(19) United States
(12) Patent Application Publication
(10) Pub. No.: US 2009/0267735 A1
(43) Pub. Date: Oct. 29, 2009

(54) FINGERPRINT AUTHENTICATION METHOD IN HUMAN BODY COMMUNICATION

(76) Inventors: Jung Bum KIM, Daejeon (KR); Tae Wook KANG, Daejeon (KR); Kyung Soo KIM, Daejeon (KR); Sung Eun KIM, Seoul (KR); Jin Kyung KIM, Daejeon (KR); Hyung Il PARK, Daejeon (KR); In Gi LIM, Daejeon (KR); Chang Hee HYOUNG, Daejeon (KR); Jung Hwan HWANG, Daejeon (KR); Ki Hyuk PARK, Daejeon (KR); Jae Hoon SHIM, Daejeon (KR); Sung Weon KANG, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/423,923

(22) Filed: Apr. 15, 2009

(30) Foreign Application Priority Data
Apr. 28, 2008 (KR) 10-2008-0039282

(51) Int. Cl. G06F 7/04

(52) U.S. Cl. 340/5.83

(57) ABSTRACT

There is provided a fingerprint authentication method in human body communication capable of transmitting/receiving data through the fingerprint authentication. The fingerprint authentication method in human body communications is capable of classifying data about two users, which carry about a human body communication equipment, into disclosure information, protection and security information according to a predetermined security level and allowing the two users to communicate the data through contact with the human skin in the human body communication environment using a human body as a communication medium, wherein the protection and security information each having a high protection level are transmitted/received after exchanging fingerprint information and conducting the fingerprint authentication.

### CROSS-REFERENCE TO RELATED APPLICATIONS

This application claims the priority of Korean Patent Application No. 2008-39282 filed on Apr. 28, 2008, in the Korean Intellectual Property Office, the disclosure of which is incorporated herein by reference.

### BACKGROUND OF THE INVENTION

1. Field of the Invention

The present application relates to a fingerprint authentication method in human body communications capable of classifying data about two users, which carry about a human body communication equipment, into disclosure information, protection and security information according to a predetermined security level and allowing the two users to communicate the data through contact with the human skin in the human body communication environment using a human body as a communication medium, wherein the protection and security information each having a high protection level are transmitted/received after exchanging fingerprint information and conducting the fingerprint authentication.

2. Description of the Related Art

In the information exchange environment with which popularization of IT (Information Technology) industry is rapid progress, it is technical challenges to prevent information owned by individuals, organizations or companies, to protect the operations of apparatuses, and to authenticate the users in the internet commercial transactions.

Current a way of authentication have used bio-information such as a face, a pupil, a fingerprint, a vein pattern and the like, which are all obtained from a human body, and also used authentication data registered in the certificate authorities concerned along with passwords.

Also, communication between human beings, and communication between a human being and an input/output unit of IT equipment (e.g., a printer, a digital display device, a portable multimedia player, a portable mobile communication equipment and the like) have been known in the field of human body communication (hereinafter, referred to as HBC) using a human body as a communication medium, which are on the rise, but are under development to put the communication systems to practical use. In particular, when both users use their human bodies as subjective users to communicate with each other, an authentication method for controlling random communication operations and protecting user's information, and an authentication equipment using the same are necessarily needed.

The standardization of this HBC remains to be published, and is in conference in the subtitle of body area network (BAN) in the IEEE 802.15 Working Group WPAN (Wireless Personal Area Network).

The HBC refers to a technology of transmitting signals between one human body and another's, or between a human body and electronic devices coupled to the human body using the conductive human body as a communication channel. These HBC technologies are mainly divided into two approaches: one is to use a human body and an electric field generated around the human body, and the other is to directly transmit a digital signal through the human skin.

The former technology uses an electric filed formed on the human body and clothes as a communication path, and the latter technology uses an inner part and surface of a human skin as a communication path when the digital signal is applied through electrodes attached to the human skin. Here, the present application is based on the latter technology.

In terms of the practical use of the HBC, an authentication procedure between a subjective user and an objective user (human beings or IT equipment) in the field of HBC is also essential to protect information of both of the users.

In case an objective of HBC is electronic equipment (for example, a printer), there has been recently proposed a method for authenticating a fingerprint in the communication environment where the electronic equipment is coupled to an internet network. Here, the method comprises: storing fingerprint information for user's identification and authentication in a database (DB) on its network, and comparing fingerprint information taken from a fingerprint identification unit coupled to the electronic equipment on the spot with fingerprint information stored in the DB. However, when there is a demand for the fingerprint authentication, the above-mentioned method has a disadvantage in that the stored fingerprint information should be extracted from the database of a client's server on the network.

Meanwhile, when an authentication file, which is contracted for the financial settlement or commercial transaction in the internet network environment, is used, input devices (e.g., a keyboard, a keypad and the like) are required to input password information as in the current authentication procedure. Therefore, this authentication procedure causes the difficulty concerning the use of the input devices due to the limitation on the physical sizes of the input devices.

### SUMMARY OF THE INVENTION

The present application is designed to solve the problems of the prior technologies, and therefore it is an object of the present application to provide a fingerprint authentication method in HBC capable of securely protecting users' information and easily communicating user's desired information when a HBC is conducted between users, by directly exchanging fingerprint information (i.e. a fingerprint certification) using a HBC equipment carried by each of two users, taking a fingerprint on the spot using a fingerprint authentication device attached to the HBC equipment, and authenticating the taken fingerprint by comparing the taken fingerprint with the exchanged fingerprint information.

According to an aspect of the present application, there is provided a fingerprint authentication method in HBC (Human Body Communication) in which two users carrying a HBC-unit transmit/receive data through human-body contacts, comprising: selecting one communication mode from a group consisting of a stand-by mode, a disclosure mode, a protection mode and a security mode; sending a communication start signal to a receiver side to determine whether a HBC according to the selected mode is available; and transmitting fingerprint information according to the selected mode to the receiver side when a communication acceptance signal is received in response to the communication start signal, receiving a fingerprint authentication result for the fingerprint information from the receiver side, and transmitting data to the receiver side.

In this case, the data are classified into disclosure information acquired without the fingerprint authentication, and protection and security information acquired with the fingerprint authentication, depending on a predetermined security level.

Also, the operation of transmitting fingerprint information comprises: transmitting the fingerprint information to the receiver side when the selected mode is the protection mode; and transmitting the data to be transmitted to the receiver side when a communication acceptance signal for the fingerprint information is received.

In addition, the operation of transmitting fingerprint information comprises: transmitting the data to the receiver side when the selected mode is the security mode and the fingerprint authentication result is true, wherein the fingerprint authentication result is obtained by comparing a fingerprint taken on the spot with previously transmitted fingerprint information.

According to another aspect of the present application, there is provided a fingerprint authentication method in HBC (Human Body Communication) in which two users carrying a HBC-unit transmit/receive data through human-body contacts, comprising: receiving a communication start signal for a communication mode selected in a transmitter side; sending a information on whether the communication is allowed in response to the communication start signal to the transmitter side; sending a response to a received fingerprint information or a fingerprint authentication result obtained by executing the fingerprint authentication, depending on the communication mode selected in the transmitter side; and receiving data from the transmitter side.

In this case, the data are classified into disclosure information acquired without the fingerprint authentication, and protection and security information acquired with the fingerprint authentication, depending on a predetermined security level.

Also, the communication mode selected in the transmitter side comprises one communication mode selected from a group consisting of a stand-by mode, a disclosure mode, a protection mode and a security mode.

Additionally, the fingerprint authentication method further comprising: receiving the fingerprint information from the transmitter side when the communication mode selected in the transmitter side is the protection mode; and sending a communication acceptance signal to the transmitter side in response to the received fingerprint information after storing the fingerprint information.

Furthermore, the fingerprint authentication method further comprising: taking a fingerprint on the spot through a fingerprint input window when the communication mode selected in the transmitter side is the security mode, and determining whether the taken fingerprint matches with the received fingerprint information; sending the determination result to the transmitter side when the determination result is true; and requesting the re-input of a fingerprint through the fingerprint input window when the determination result is false.

### BRIEF DESCRIPTION OF THE DRAWINGS

The above and other aspects, features and other advantages of the present application will be more clearly understood from the following detailed description taken in conjunction with the accompanying drawings, in which:

FIG. 1 is a block diagram illustrating HBC-units to transmit/receive data by means of a fingerprint authentication according to one exemplary embodiment of the present application.

FIG. 2 is a diagram illustrating a fingerprint authentication procedure to transmit/receive data between the HBC-units 1 and 2 for two users (a subjective User A and an objective User B), depending on the disclosure mode or protection mode, as shown in FIG. 1.

FIG. 3 is a diagram illustrating a fingerprint authentication procedure to transmit/receive data between the HBC-units 1 and 2 for two users (a subjective User A and an objective User B), depending on the security mode, as shown in FIG. 1.

FIG. 4 is a flowchart illustrating a fingerprint authentication method in HBC to transmit data according to one exemplary embodiment of the present application.

FIG. 5 is a flowchart illustrating a fingerprint authentication procedure of a fingerprint authentication block in the HBC-unit to transmit/receive data by means of the fingerprint authentication as shown in FIG. 1.

### DETAILED DESCRIPTION OF THE PREFERRED EMBODIMENT

Hereinafter, exemplary embodiments of the present application, which may be easily taken into practice by those skilled in the art, will be described in detail with reference to the accompanying drawings.

For the exemplary embodiments of the present application, detailed descriptions of known functions and constructions that are related to the present application are omitted for clarity when they are considered to make the gist of the present application unnecessarily confusing.

Furthermore, for reference numerals that are marked hereinafter in the accompanying drawings, parts and their related counterparts that have the same functions and operations are represented by the same numbers or their serial numbers over the specification of the present application.

Over the specification of the present application, when one part is ‘coupled’ to another part, the term ‘coupled’ refers to the one part being connected either ‘directly’ or ‘indirectly’ through an intervening component to the another part.

Furthermore, ‘including’ some components shall be construed not to exclude the other components but to cover the other components, unless otherwise stated herein.

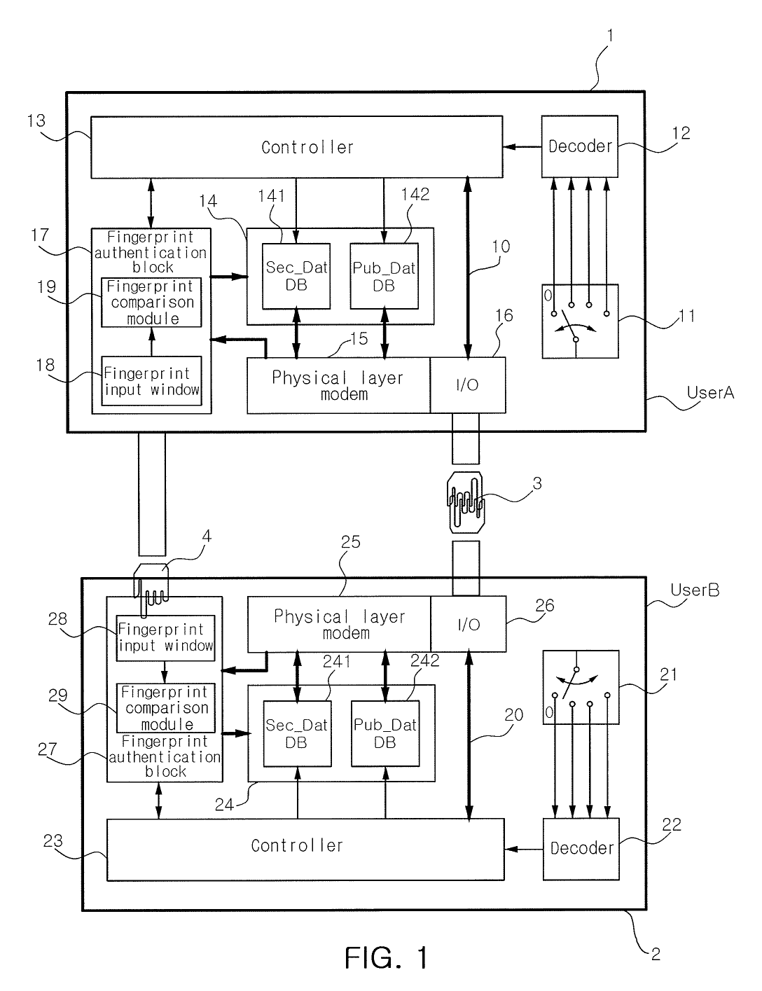

FIG. 1 is a block view illustrating HBC-units to transmit/receive data by means of the fingerprint authentication according to one exemplary embodiment of the present application. Two users (i.e. a subjective User A and an objective User B) carry their own terminals having HBC-units 1 and 2 as its basic built-in unit, respectively.

Here, when the two users' skins are in contact with each other, for example hand-shaking (hereinafter, referred to as ‘human body contact’), the HBC between two users are set to transmit/receive digital data contracted for them using the users' own body as a communication channel.

Also, the kinds of data that may be transmitted/received between both users is classified according to the level of protection, that is, a predetermined security level, and includes disclosure information such as a business card, protection information requiring the confidentiality of individuals or organizations and companies, and security information such as certain agreement documents (digital files) contracted by both sides in the business contract entailing legal responsibilities.

In particular, the security information refers to information on business contracts such as real estate transactions requiring a seal (or a registered seal) on the spot of transaction, transactions of special products (when they requires continuous technical supports during their use), and information which certain group members in any organizations are allowed to make an access to.

Therefore, the HBC-unit of the present application applies the fingerprint authentication method in HBC to the communications of protection and security information, which have a higher security level among the three kinds of disclosure information, protection and security information.

Specifically, the fingerprint authentication method in HBC according to the present application includes: previously storing the same fingerprint information in a user's terminal as fingerprint information which has been registered and authenticated by the certificate authorities concerned, transmitting/receiving the user's own fingerprint information for HBC under the users' agreement, and communicating data of the protection information. Here, the fingerprint authentication for the protection information is conducted only by the exchange of the fingerprint certificate.

Also, when users' private seals are required for HBC under the users' agreement, for example, the fingerprint authentication method in HBC of security information includes: taking a fingerprint on the spot of transaction using a fingerprint authentication block installed in the HBC-unit, conducting the fingerprint authentication, checking the users' identities and fingerprint information, and exchanging data of security information under the users' agreement.

In this case, even when it is unnecessary to take a fingerprint in the fingerprint authentication method in HBC of protection information, the exchange of the user's own fingerprint information may be used as the agreed evidence of the both users when there is any possibility of making continuous transactions. This implies meanings such as client managements and credit accumulations from the users' own points of view on the HBC, and therefore is considered in terms of the use of the HBC. For the applications, it is preferred to communicate disclosure information, protection and security information in their order so as to protect personal information and business information, but it is also possible to communicate security information at the beginning.

The fingerprint authentication of the users of the HBC is preferably conducted using a Minutia or frequency analysis method that has been known to have lower possibility of plagiarizing a fingerprint than a conventional pattern matching method in which a fingerprint is simply compared with image data.

The descriptions of the method for recognizing a fingerprint and the specific authentication technology are out of the scope of the present application, and the methods used for the fingerprint authentication in the HBC is described in the present application by using the general concepts of the fingerprint recognition. Therefore, the descriptions of the method for recognizing a fingerprint and the specific authentication technology are omitted for clarity.

A fingerprint certificate such as a certificate file used in the internet banking which is registered in certified authentication authorities in advance is used as the fingerprint information.

Then, the fingerprint authentication procedure for communicating data between both User A and User B is now described in more detail. In this HBC, the User A is set to a subjective user and the User B is set to an objective user.

As shown in FIG. 1, the HBC-units 1 and 2 carried respectively by the User A and User B may have different external shapes, depending on the kinds of terminals that the users have (portable mobile communication equipment or moving picture equipment, etc.), but the User A and User B have the HBC-units 1 and 2 installed therein, respectively, or carry the HBC-units 1 and 2 as stand-alone devices, respectively.

Here, since the HBC-units 1 and 2 carried respectively by the User A and User B have the same configuration, the case that a communication subjective is set to the HBC-unit 1 of the User A is described in more detail.

The HBC-unit 1 comprises a switch 11, a decoder 12, a controller 13, a database 14, a physical layer modem 15, an I/O (Input/Output) module 16 and a fingerprint authentication block 17.

The HBC-Unit 1 initiates communication by selecting the switch 11 to determine a communication mode, depending on the security level of the data to be transmitted.

Specifically, the switch 11 select one of four states including a disclosure information transmission state, a protection information transmission state, and a security information transmission state, which is correspond to disclosure information, protection and security information. More specifically, the switch 11 sets the stand-by state to “0” the disclosure information communication state to “1” the protection information communication state to “2” and the security information communication state to “3”, respectively.

That is, the four states selected in the switch 11 are set to 4 communication modes, respectively. For the 4 communication modes, M0 (switch “0”) represents a stand-by mode, M1 (switch “1”) represents a disclosure mode, M2 (switch “2”) represents a protection mode, and M3 (switch “3”) represents a security mode.

The decoder 12 classifies signals according to the one state selected by the switch 11, and generates a signal corresponding to one communication mode out of the 4 communication modes (M0, M1, M2 and M3).

The controller 13 controls and manages each component according to the input signal corresponding to the communication mode transmitted from the decoder 12 in order to conduct the HBC according to the communication mode. Also, the controller 13 manages and monitors the transmission/reception of input/output signals and data to/from a communication objective user. And when the controller 13 receives data, the controller 13 determines the kind of the communication mode corresponding to the input signal transmitted from a transmitter side of User B, and informs a user of the kind of the communication by mean of a component such as a speaker or a lamp fixed to the HBC-unit. In this procedure, it is possible to match the two users' communication modes with each other.

The DB (database) 14 includes a Sec_Dat DB 141 as a protection memory and a Pub_Dat DB 142 as a disclosure memory. Here, protection and security information including a user's own fingerprint information is stored in the Sec_Dat DB 141 in order to authenticate against a communication objective user, and disclosure information such as a business card, which is used to introduce oneself, is stored in the Pub_Dat DB 142.

All information including a fingerprint certificate received from the user B is stored in the Sec_Dat DB 141, and the distinction from the user's own protection information (Sec_Dat) may be managed by separating addresses of a memory designed, or assigning the addresses of the memory to specific addresses by the controller 13.

The fingerprint authentication block 17 conducts the fingerprint authentication by taking a fingerprint 4 in order to authenticate against a user according to the users' agreement, recognizing the taken fingerprint 4 and comparing the recognized fingerprint with the stored fingerprint information to determine whether the recognized fingerprint matches with the previously stored fingerprint information.

The physical layer modem 15 selects a communication band according to the noise characteristics of a human body channel, spread-modulates digital data of a baseband within the communication band, and transmits those data through an electrode coupled to the HBC-unit. Furthermore, the physical layer modem 15 receives data by filtering of noise and retiming those at an analog circuit block and then despread-demodulating those data in a baseband.

The I/O module 16 is coupled connected to the controller 13 through a signal bus 10, and may be incorporated into the physical layer modem 15. This I/O module 16 sends a signal to the controller 13 via the signal bus 10, the signal being allowed to determine the start/end of the intercommunications between the HBC-units 1 and 2 and the completion of transmission/reception of certain data when human bodies of the User A and User B are in contact with each other. Meanwhile, detailed description of the external components, such as the electrode, which are attached to the outside of the HBC-unit and come in contact with the human skin, is omitted.

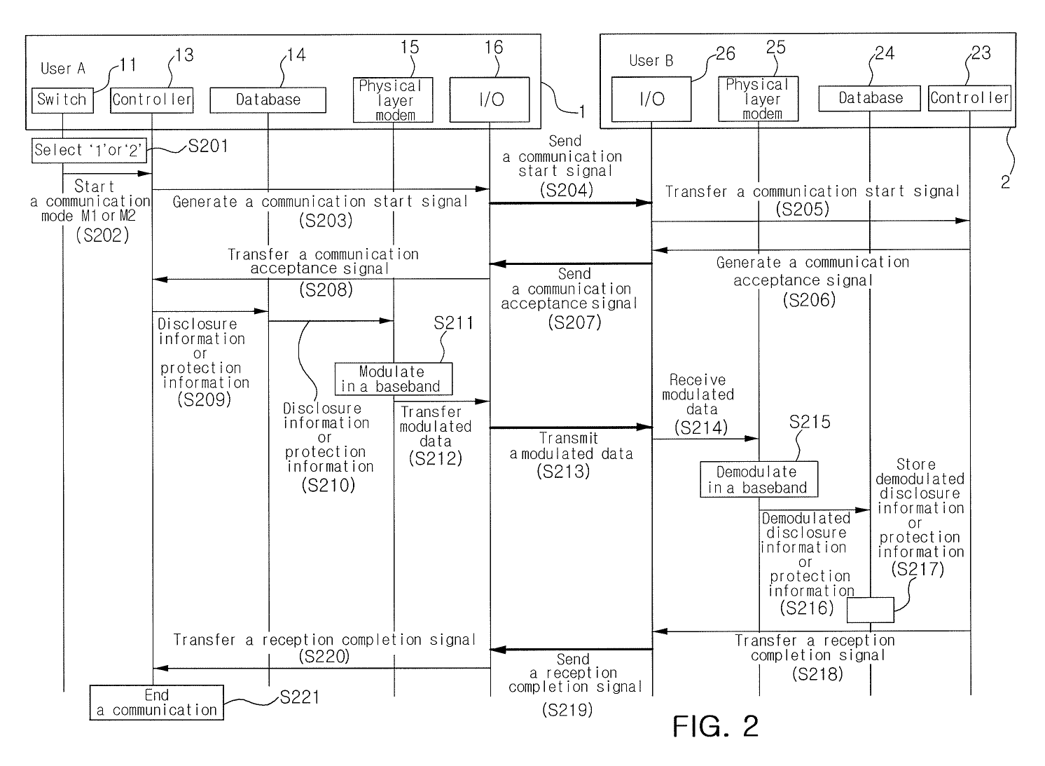

Hereinafter, the exemplary embodiments of the operations of the communication modes for disclosure information, protection and security information are described in more detail with reference to FIG. 2 to FIG. 4. Here, each of the communication modes is driven according to the kinds of data in the HBC environment of the HBC-unit 1 as shown in FIG. 1. In the descriptions of the exemplary embodiments, the operations are described on the assumption that the human body contact between users is maintained until the HBC is finished. However, a waiting time where the HBC is suspended for a while (i.e. taking a fingerprint) is set to a suitable time by the controller 13 according to one exemplary embodiment of the present application.

<Transmission of Disclosure Information or Protection Information>

FIG. 2 is a diagram illustrating a fingerprint authentication procedure to transmit/receive data between the HBC-units 1 and 2 for two users (wherein User A is a subjective user and a User B is an objective user) as shown in FIG. 1, depending on the disclosure mode or protection mode. Here, the disclosure and protection information of the User A are stored in advance as digital data in the Pub_Dat DB 142 and the Sec_Dat DB 141, respectively, and the HBC-units 1 and 2 are initially set to a stand-by state.

Also, the disclosure information includes digital data such as a business card used for users' own public relations, materials for information or publicity of business. Also, the protection information includes digital data of a fingerprint certificate, which is authenticated by registering a user's own fingerprint in the certified authorities, and protection information of individuals, organizations or companies.

As shown in FIG. 2, when the switch 11 is set to “1” by the User A (S201), a disclosure mode M1 starts to be driven (S202). Also, when switch 11 is set to “2” by the User A (S201), a protection mode M2 starts to be driven (S202).

When the User A is in human body contact 3 with the User B, the User A generates and sends a communication start signal to the User B (S203 and S204).

When the User B receives the communication start signal (S205), the User B responds to the User A by sending a communication acceptance signal (S206 and S207).

When the selected mode is the disclosure mode M1, the User A receives the communication acceptance signal (S208), and transfers disclosure information of the User A to the physical layer modem 15 (S208, S209 and S210). And, the physical layer modem 15 conducts a baseband modulation of the data (S211), and the modulated data is transmitted to the User B (S212 and S213). That is, the disclosure mode M1 transmits the data without the fingerprint authentication procedure.

Meanwhile, when the selected mode is the protection mode M2, the User A receives the communication acceptance signal (S208), transmits a user's own fingerprint information and waits for the response from the User B. In this case, the User B stores the received fingerprint information in the Sec_Dat DB 241, and sends a communication acceptance signal again. That is, the fingerprint authentication for the protection mode M2 is conducted only by transmitting the fingerprint information.

Then, when the User A receives the communication acceptance signal, the User A transfers his own protection information (Sec_Dat) to the physical layer modem 15 (S209 and S210), the physical layer modem conducts a baseband modulation of the data (S211), and the modulated data is transmitted to the User B (S212 and S213).

The physical layer modem 25 of the User B receives the modulated data (S214), conducts a baseband demodulation of the received data (S215), and stores the demodulated data in the Sec_Dat DB 241 of the database 24 (S217).

Subsequently, the controller 23 of the User B sends a reception completion signal to the User A (S218 and S219).

In case the User B requires further data of the User A, the User B re-sends the communication acceptance signal to the User A, and sends the reception completion signal to the User A after receiving the data of the User A.

The User A receives the reception completion signal via the I/O module 16 and the signal bus 10 (S220), and finishes the HBC with User B (S221).

The signals and data transmitted from the User A as shown in FIG. 2, that is, the control signal generated in the controller 13 and the data modulated by the physical layer modem 15, are transmitted via the I/O module 16 when both the users are in human body contact 3 with each other. In the HBC-Unit of the User B, the transmission direction of the baseband-demodulated data from the physical layer modem 25 to the database 24 for storage is opposite to the HBC-unit of the User A. Meanwhile, when a subjective user is set to User B, and an objective user is set to User A, the HBC may be easily conducted, without any technical problems, in a reverse manner to the above-mentioned communication procedure.

<Transmission of Security Information by Fingerprint Authentication>

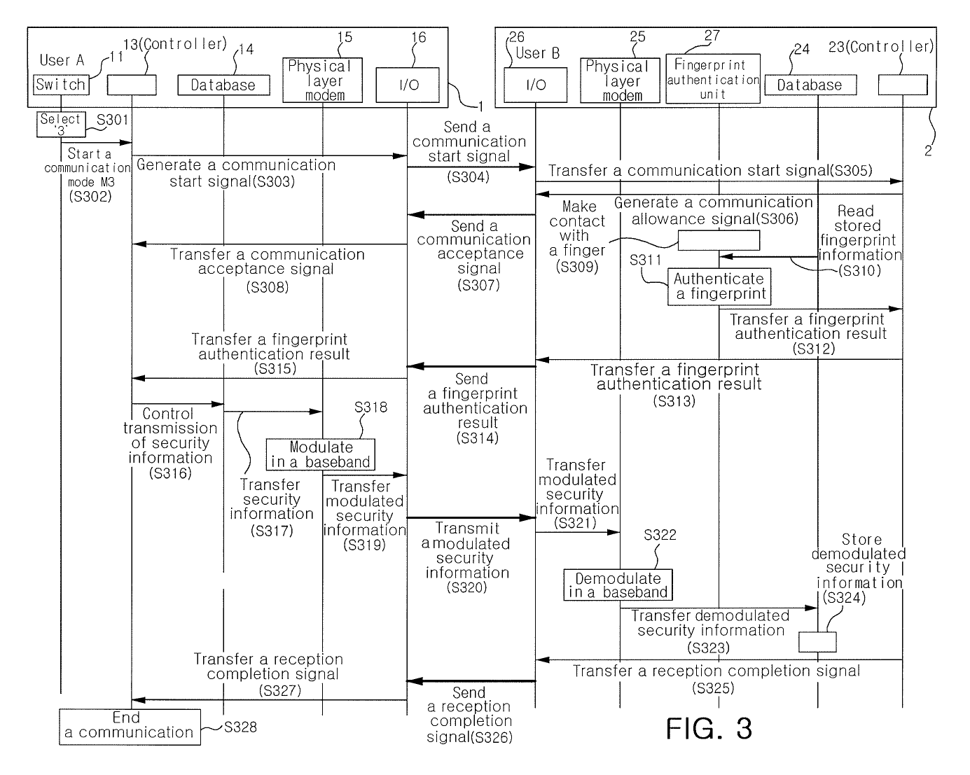

FIG. 3 is a diagram illustrating a fingerprint authentication procedure to transmit/receive data between the HBC-units 1 and 2 for two users (wherein User A is a subjective user and a User B is an objective user), depending on the security mode M3.

As shown in FIG. 3, when the switch 11 is set to “3” by the User A (S301), a security mode M3 starts to be driven with the recognition of a fingerprint (S302).

When the User A is in human body contact 3 with the User B, the User A sends a communication start signal to the User B (S303 and S304). When the User B receives the communication start signal (S305), the User B responds to the User A by sending a communication acceptance signal (S306 and S307).

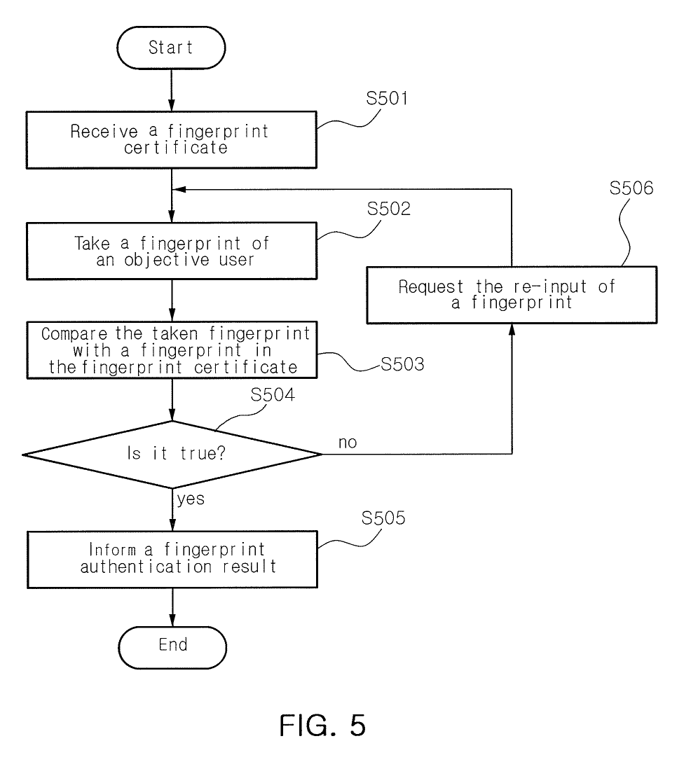

The User A receiving the communication acceptance signal (S308) comes in contact with a fingerprint input window 28 of the fingerprint authentication block 27 in the User B's HBC-unit 2 (S309), and the fingerprint authentication block 27 of the User B takes a User A's fingerprint. Then, the taken fingerprint is compared with stored fingerprint information of the User A, which has been stored in the Sec_Dat DB 241 in the protection mode M2(310), and the User B determines whether the taken fingerprint matches with the fingerprint information of the User A (S311). The fingerprint authentication procedure of the fingerprint authentication block 27 is described in more detail with reference to FIG. 5.

The User B sends the fingerprint authentication results to the User A (S312, S313 and S314).

The User A receiving the fingerprint authentication results (S315) transfers his own security information to the physical layer modem 15 (S316 and S317), and the physical layer modem 15 conducts a baseband modulation of the security information (S318), and the modulated security information is transmitted to the User B (S319 and S320).

The physical layer modem 25 of the User B receiving the modulated security information of User A, and demodulates the modulated security information in a baseband (S322), and stores the demodulated security information in the Sec_Dat DB 241 of the database 24 (S323 and S324).

Then, the User B sends a reception completion signal to the User A (S325 and S326).

The User A receiving the reception completion signal finishes the communication (S327 and S328).

The signals and data received from the User A as shown in FIG. 3 are transmitted/received in the same manner as the transmitting/receiving methods described in disclosure mode M1 or protection mode M2 as shown in FIG. 2. Meanwhile, when a subjective user is set to User B, and an objective user is set to User A, the HBC may be easily conducted, without any technical problems, in a reverse manner to the above-mentioned communication procedure.

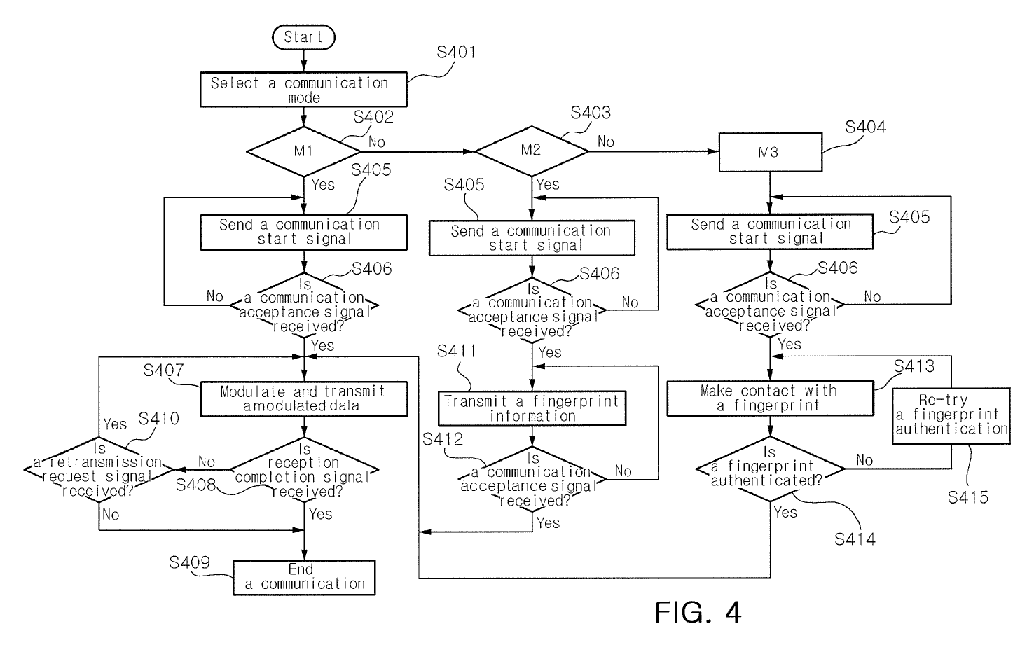

FIG. 4 is a flowchart illustrating a fingerprint authentication method in HBC to transmit data according to one exemplary embodiment of the present application.

Referring to FIG. 4, a state of the switch 11 is selected according to the kinds of data classified according to the predetermined security level of information, and a communication mode corresponding to the selected state is set (S401).

When the state of the switch 11 is divided into “0” “1” “2” and “3” and an operation mode according to the selected state of the switch 11 includes a stand-by mode M0, a disclosure mode M1, a protection mode M2 and a security mode M3.

The HBC-unit according to one exemplary embodiment is basically set as the stand-by mode M0, and then selects a communication mode corresponding to Step S401.

In this case, when the corresponding communication mode is M1 (S402), the HBC-unit 1 of the User A as the subjective user sends a communication start signal to the User B as an objective user through the human body contact (S405).

Then, when the User A receives the communication acceptance signal from the objective User B (S406), the HBC-unit 1 of the User A conducts a baseband modulation of data to be transmitted and transmits the modulated data to the User B (S407).

Meanwhile, when the corresponding communication mode is M2 (S403), the HBC-unit 1 of the User A sends the communication start signal to the User B through the human body contact (S405).

Then, when the User A receives a communication acceptance signal from the User B (S406), the User A transmits fingerprint information to the User B (S411). And when the User A receives a communication acceptance signal from the User B (S412), the HBC-unit 1 of the User A modulates the data in the physical layer modem 15, and transmits the modulated data to the User B (S407).

Subsequently, when the User A receives the sent reception completion signals for the modulated data from the User B (S408, YES), the User A finishes the communication (S409). On the contrary, when the User A does not receive the reception completion signal (S408, NO), the User A checks whether it receives a retransmission request signal for data (S410).

As the results of Step S410, when the User A receives a retransmission request signal (S410, YES), the User A repeats Step S407 again.

Meanwhile, when the corresponding communication mode is M3 (S404), the User A receives a communication acceptance signal from the User B (S406). In this case, the User A takes a fingerprint by making a contact with a fingerprint input window 28 of the fingerprint authentication block 27 which is installed inside the HBC-unit of the User B (S413).

And, the User B has previously received and stored fingerprint information of the User A under the protection mode M2. Then, when the security mode M3 starts to be driven, the User B determines whether the taken fingerprint matches with the previously stored fingerprint information by a fingerprint authentication procedure, instead of using a seal (i.e. a registered seal) on the spot of transaction according to the users' advance agreement for HBC. Then, the User B sends the determination results to User A.

When the User A receives the fingerprint determination results from the User B, and determines that the taken fingerprint does not match with the previously stored fingerprint information of the User A (S414, NO), the User A requests the recontact of a fingerprint (S415). Otherwise they does match (S414, YES), the User A finishes the communication by undergoing Step S407 to S410 as described above.

FIG. 5 is a flowchart illustrating a fingerprint authentication procedure of a fingerprint authentication block 27 in the HBC-unit to transmit/receive data by means of the fingerprint authentication as shown in FIG. 1.

As shown in FIG. 5, the User B receives a fingerprint certificate of the User A registered in the certificate authorities concerned by means of the protection mode M2 (S501).

Then, when the security mode M3 starts to be driven, the User B takes a fingerprint when a finger of the User A comes in contact with the fingerprint input window 28 of the HBC-unit 2 of the User B, but not in contact with the HBC path (S502). In this case, the fingerprint comparison module 29 of the User B compares the fingerprint taken on the spot with the previously received fingerprint information (S503).

The fingerprint comparison module 29 determines whether the taken fingerprint matches with the previously received fingerprint information by using a judgment flag which is the comparison results of Step S503 (S504). When the determination results of Step S504 is true, the determination results are transferred to the controller 23 of the User B. Then, the controller 23 informs the HBC-unit 1 of the User A of the determination results indicating the fingerprint recognition is successful (S505). When the determination results of Step S504 is false, the User B requests the re-input of a fingerprint (S506) to take a fingerprint on the fingerprint input window 28 again (S502). In accordance the present application, the User A may be informed of the request for the re-input of a fingerprint (S506) by mean of a component such as a speaker or a lamp fixed to a HBC-unit. Although the User A is the same person, the re-input of a fingerprint is requested in consideration that the taken fingerprint may not match with the previously stored fingerprint information according to the status of the taken fingerprint. In order to prevent attempts of other users to make a fingerprint contact by intent and maintain the security, it is preferred to limit the number of the fingerprint contacts according to one exemplary embodiment.

Meanwhile, when the User A should further transmit a document file such as a contract according to the users' agreement, the User A transmits the document file by the security mode M3. When the transmission from the User A is completed, the User B sends a reception completion signal to the User A.

In the fingerprint recognition procedure, the persons to a contract may exchange their own identities and evidence of contract. Also, a digital data file making procedure, which including: taking a fingerprint, recognizing the taken fingerprint and converting data of the fingerprint into the digital data file, may be carried out by using the conventional fingerprint recognition and authentication technologies. Here, the description of the fingerprint recognition and the authentication technologies is omitted for clarity. However, the HBC-unit according to the present application should make out a fingerprint certificate regarding the taken fingerprint at the controllers 13 or 23 by using the same conventional algorithm as in the fingerprint certificate, and authenticate the fingerprint certificate at the fingerprint authentication blocks 17 or 27.

Although both of the subjective and objective users are set to persons for the HBC according to the present application, IT equipment may be also used as the communication objective user. In this case, the services of communication equipment and the users' desired transactions may be expendable through the fingerprint authentication by using the protection mode M2.

As described above, the fingerprint authentication method in HBC may be useful to easily communicate user's desired information by classifying data to be transmitted into disclosure information, protection and security information according to a predetermined security level of information and conducting the HBC by means of the exchange of fingerprint information and the fingerprint authentication only in transmitting the protection and security information each having a high protection level. Also, the fingerprint authentication method in HBC may be useful to enhance the hiding and protective properties of information so as to securely protect the users' information by exchanging fingerprint information stored in a HBC-unit carried by each of two users and authenticating in comparison of the fingerprint taken on the spot with the exchanged and stored fingerprint information.

And, the exemplary embodiments of the present application have been described in detail referring to the accompanying drawings. However, it should be understood that the description proposed herein is just a preferable example for the purpose of illustrations only, not intended to limit the scope of the invention, so it should be understood that other equivalents and modifications could be made thereto without departing from the concept and scope of the invention.

What is claimed is:

1. A fingerprint authentication method in HBC (Human Body Communication) in which two users carrying a HBC-unit transmit/receive data through human-body contacts, comprising:
selecting one communication mode from a group consisting of a stand-by mode, a disclosure mode, a protection mode and a security mode;
sending a communication start signal to a receiver side to determine whether a HBC according to the selected mode is available; and
transmitting fingerprint information according to the selected mode to the receiver side when a communication acceptance signal is received in response to the communication start signal, receiving a fingerprint authentication result for the fingerprint information from the receiver side, and transmitting data to the receiver side.

2. The fingerprint authentication method of claim 1, wherein the data are classified into disclosure information acquired without the fingerprint authentication, and protection and security information acquired with the fingerprint authentication, depending on a predetermined security level.

3. The fingerprint authentication method of claim 2, wherein the operation of transmitting fingerprint information comprises:
sending the fingerprint information to the receiver side when the selected mode is the protection mode; and
transmitting the data to be transmitted to the receiver side when a communication acceptance signal for the fingerprint information is received.

4. The fingerprint authentication method of claim 3, wherein the operation of transmitting fingerprint information comprises:
transmitting the data to the receiver side when the selected mode is the security mode and the fingerprint authentication result is true, wherein the fingerprint authentication result is obtained by comparing a fingerprint taken on the spot with previously transmitted fingerprint information.

5. A fingerprint authentication method in HBC (Human Body Communication) in which two users carrying a HBC-unit transmit/receive data through human-body contacts, comprising:
receiving a communication start signal for a communication mode selected in a transmitter side;
sending a information on whether the communication is allowed in response to the communication start signal to the transmitter side;
sending a response to a received fingerprint information or a fingerprint authentication result obtained by executing the fingerprint authentication, depending on the communication mode selected in the transmitter side; and
receiving data from the transmitter side.

6. The fingerprint authentication method of claim 5, wherein the data are classified into disclosure information acquired without the fingerprint authentication, and protection and security information acquired with the fingerprint authentication, depending on a predetermined security level.

7. The fingerprint authentication method of claim 5, wherein the communication mode selected in the transmitter side comprises one communication mode selected from a group consisting of a stand-by mode, a disclosure mode, a protection mode and a security mode.

8. The fingerprint authentication method of claim 6, further comprising:
receiving the fingerprint information from the transmitter side when the communication mode selected in the transmitter side is the protection mode; and
sending a communication acceptance signal to the transmitter side in response to the received fingerprint information after storing the fingerprint information.

9. The fingerprint authentication method of claim 8, further comprising:
taking a fingerprint on the spot through a fingerprint input window when the communication mode selected in the transmitter side is the security mode, and determining whether the taken fingerprint matches with the received fingerprint information;
sending the determination result to the transmitter side when the determination result is true; and
requesting the re-input of a fingerprint through the fingerprint input window when the determination result is false.
